(19) United States
(12) Patent Application Publication
(10) Pub. No.: US 2010/0080026 A1
(43) Pub. Date: Apr. 1, 2010

(54) POWER FACTOR CORRECTION CIRCUIT

(76) Inventor: Xiaoyang Zhang, Richardson, TX (US)

Correspondence Address: MARSH, FISCHMANN & BREYFOGLE LLP, 8055 East Tufts Avenue, Suite 450, Denver, CO, 80237, US

(21) Appl. No.: 12/243,082

(22) Filed: Oct. 1, 2008

(51) Int. Cl. H02M 7/155

(52) U.S. Cl. 363/89

(57) ABSTRACT

A power converter that is operable to convert AC power into DC power that may be delivered to a load. The power converter operates to bypass a power factor correction (PFC) circuit during a portion of each AC power cycle. The power converter bypasses the PFC circuit when an AC input voltage is greater than a DC output voltage. The power converter may also include sensing circuitry to sense the AC input voltage and the DC output voltage of the power converter. The power converter may include one or more diodes that function to deliver power directly to a load when the AC input voltage is greater than the DC output voltage, thereby bypassing the PFC circuit. The DC output voltage of the power converter may be regulated to a level that is less than the peak AC input voltage.

### BACKGROUND

Electronic devices such as notebook computers, desktop computers, monitors, and the like typically receive power from an AC power source. However, in most instances, the devices require DC power to operate, so the power from the AC power source must converted to DC power. The simplest way to accomplish this is by diode rectification circuitry. In this type of circuit, diodes are positioned in a circuit so that AC current flows in only one direction, so that the output of the rectifier maintains a non-negative voltage. This method is typically the least expensive AC-DC conversion scheme, but it also creates the most noise or “pollution” on the AC power network. This is the case because when a power converter is coupled to loads that are not purely resistive (e.g., reactive loads that include capacitors and inductors), the current drawn from the AC power source may be out of phase with the AC voltage, which may lead to increased harmonics. Therefore, if used in large numbers, devices that use this method can greatly impact the quality of the AC power line. Additionally, reactive loads cause power converters to be less efficient. Energy stored in the reactive loads results in a time difference between the current and voltage waveforms. This stored energy returns to the power source and is not available to do work at the load, so the “real power” of the circuit is less than the “apparent power.” The ratio of real power to apparent power is generally referred to as the power factor of a circuit. As can be appreciated, a circuit with a low power factor will be required to draw greater current to transfer a given quantity of real power than a circuit with a high power factor, which translates to increased losses in power distribution systems and increased energy costs. Hence, it is desirable to provide AC-to-DC power conversion that does not have these same shortcomings.

To achieve this, a power converter that includes power factor correction (PFC) circuitry may be used. Generally, PFC circuits have the function of maintaining the AC current substantially in phase with the AC voltage, so that the power converter resembles a purely resistive load to the AC power source, which reduces the pollution on the AC power line and increases the efficiency of the power converter. One type of PFC circuit is generally referred to as a passive PFC circuit. Passive PFC circuits perform power factor correction with only passive components, such as inductors and capacitors. Passive PFC circuits are typically robust and effective, but it is often difficult to reduce the distortion to acceptable levels. Furthermore, since passive PFC circuits operate at the relatively low line frequency (e.g., 50 Hz or 60 Hz), the inductors and capacitors required may be large in size and costly.

Another type of PFC circuit is generally referred to as an active PFC circuit. Active PFC circuits generally have at least one switch. The most commonly used active PFC circuit is based on a boost converter, which is included in a prior art PFC circuit 10 shown in FIG. 1. The PFC circuit 10 operates to shape the input current to achieve low distortion levels. Due to the use of relatively higher switching frequencies (e.g., 50 kHz to 300 kHz), the size of the associated passive components required is significantly reduced when compared to passive PFC circuits. However, as can be appreciated, typical active PFC circuits have inherent drawbacks that include lower overall power conversion efficiency due to the added switching stage and associated power losses.

The structure of the prior art active PFC circuit 10 is now described with reference to FIG. 1. As can be seen, an AC power source 14 is coupled across the input terminals of a full-wave bridge rectifier D3. A first output terminal of the bridge rectifier D3 is coupled to a first terminal of an inductor L via a node 26. A second terminal of the inductor L is coupled to a drain of a transistor switch Q and to the anode of a diode D, at a node 21. The cathode of the diode D is coupled to a first terminal of a bulk capacitor C, which forms a PFC output node 22 that may further be coupled to a load. As shown, a second output terminal of the bridge rectifier D3, the source of the transistor switch Q, and the second terminal of the capacitor C may be coupled to ground. Furthermore, a PFC control circuit 18 may be coupled to the gate of the transistor switch Q to control whether the transistor switch Q is conductive (i.e., the switch is closed) or non-conductive (i.e., the switch is open). Additionally, the PFC control circuit 18 may be operable to sense various voltage and currents in the power converter.

In operation, a current flows from the bridge rectifier D3 through the inductor L and through the switch Q when it is closed. Under such conditions, the diode D is reverse-biased by the voltage on the capacitor C (i.e., the PFC output node 22). The current flowing through the inductor L stores energy in the form of an electromagnetic field. When the switch Q is opened, the stored energy is transferred to the bulk capacitor C by a current that flows through the diode D, which is forward-biased under such conditions. The energy in the bulk capacitor C maintains the voltage at the PFC output node 22 and is available for driving a load (e.g., another power supply stage). As can be appreciated, the rate of energy transfer from the AC power source 14 to the capacitor C is dependent upon a duty cycle of the transistor switch Q. Therefore, using feedback voltage and current signals, the PFC control circuit 18 may control the times at which switching of the transistor switch Q occurs so that the AC current and AC voltage is substantially in phase, and so that the PFC output node 22 voltage is substantially maintained at a constant DC level.

Generally, the PFC circuit 10 described above may operate to boost the voltage at the PFC output node 22 to a fixed voltage, independent of the AC input voltage and the output load variation. However, in this configuration, the PFC circuit 10 must dissipate a large amount of power and heat to maintain the fixed output voltage when the AC input voltage is relatively low. This results in a PFC circuit 10 that has a reduced efficiency. To work around this problem, a “boost follower” PFC circuit may be implemented. In a “boost follower,” the PFC output voltage 22 may be variable and proportional to the AC input voltage. This configuration has the benefit of reducing the power loss in the switch Q at low AC input voltages, but has the disadvantage of requiring large and costly power components (e.g., the inductor L, the switch Q, and the diode D), to accommodate heavy load conditions.

It is against this background that the power factor correction circuit described herein has been developed.

### SUMMARY

The following embodiments and aspects of thereof are described and illustrated in conjunction with systems, tools, and methods which are meant to be exemplary and illustrative, and not limiting in scope. In various embodiments, one or more of the above-described problems have been reduced or eliminated, while other embodiments are directed to other improvements.

According to a first aspect, a power converter that is capable of receiving AC power from an AC power source on an input terminal and delivering DC power to a load on an output terminal is provided. The power converter includes a rectifier having an input terminal coupled to the AC power source, and an output terminal, the rectifier being operable to receive an AC voltage on its input terminal and deliver a rectified voltage on its output terminal. The power converter further includes a power factor correction circuit having an input terminal coupled to the output terminal of the rectifier, and an output terminal coupled to the output terminal of the power converter, the power factor correction circuit being operable to modify the power factor of the power converter, and being operable to deliver DC power to a load. Additionally, the power converter includes an auxiliary circuit that operates to bypass the power factor correction circuit when the magnitude of the voltage of an output terminal of the AC power source is greater than the voltage of the output terminal of the power converter.

According to a second aspect, a power converter that is capable of receiving AC power from an AC power source on an input terminal and delivering DC power to a load on an output terminal is provided. The power converter includes a rectifier having an input terminal coupled to the AC power source, and an output terminal, the rectifier being operable to receive an AC voltage on its input terminal and deliver a rectified voltage on its output terminal. The power converter further includes a power factor correction circuit having an input terminal and an output terminal, the input terminal being coupled to the output terminal of the rectifier, the power factor correction circuit being operable to modify the power factor of the power converter, and being operable to deliver DC power to a load. Further, the power converter includes an auxiliary circuit that operates to bypass the power factor correction circuit when the magnitude of the voltage of an output terminal of the AC power source is greater than the voltage of the output terminal of the power converter. Additionally, the power converter includes a current-shaping circuit having an input terminal that is coupled to the output terminal of the power factor correction circuit, and an output terminal that is coupled to the output terminal of the power converter, wherein the current-shaping circuit is operable to reduce the harmonic distortion of an electrical current of the AC power source.

According to a third aspect, a method is provided for use in a power converter, the power converter being operable to receive AC power from an AC power source on an input terminal and delivering DC power to a load on an output terminal. The method includes the steps of converting an input AC voltage to a rectified voltage, and supplying the rectified voltage to a power factor correction circuit, the power factor correction circuit being operable to modify the power factor of the power converter, and being operable to deliver DC power to a load. The method further includes regulating an output voltage of the power factor correction circuit to a level that is less than a peak voltage of the AC power source, and bypassing the power factor correction circuit when the magnitude of the voltage of an output terminal of the AC power source is greater than the voltage of the output terminal of the power converter.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a schematic diagram of a power converter of the prior art.

FIG. 2 is a block diagram of an application that uses a power converter.

FIG. 3 is a block diagram of an exemplary power converter.

FIG. 4 is a schematic diagram of an exemplary power converter.

FIG. 5 is a timing diagram that graphically represents four waveforms associated with an exemplary power converter, such as the power converter of FIG. 4.

FIG. 6 is a schematic diagram of another embodiment of an exemplary power converter.

FIG. 7 is a schematic diagram of another embodiment of an exemplary power converter.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

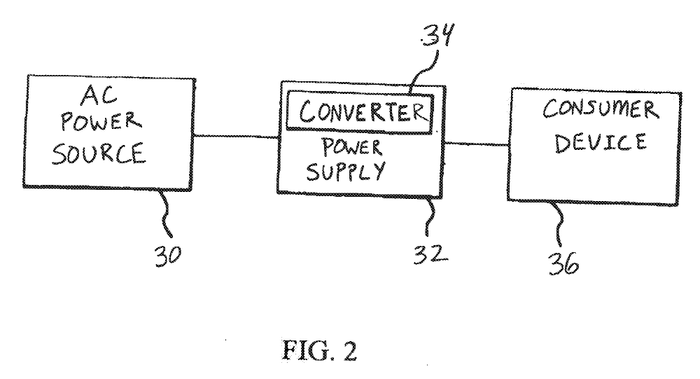

FIG. 2 illustrates an exemplary application for a power converter 34. As shown, the power converter 34 may be incorporated as a component in a power supply 32 for a consumer device 36. The consumer device may be a portable computing device (e.g., a notebook computer, a personal digital assistant, a tablet PC, or the like), or a desktop computer, mobile telephone, portable music player, or the like. The power supply 32 may function to modify the output from an AC power source 30 to a form that is suitable for the consumer device 36 (e.g., converting AC power into DC power). As discussed above, the power converter 34 may increase the power factor to an acceptable level for a particular application.

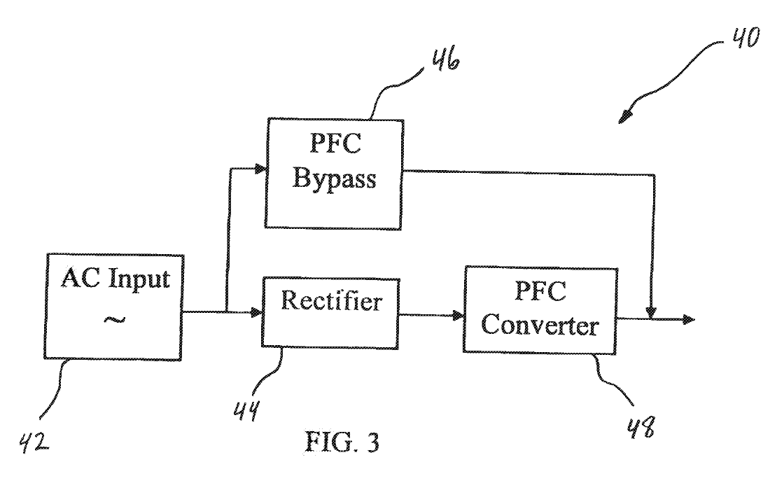

Turning now to FIG. 3, a block diagram of an exemplary power converter 40 is shown. The power converter 40 may include a rectifier 44 that is coupled to an AC power source 42. The rectifier 44 may operate to convert AC power received from the AC power source 42 into AC power that has only positive current flow. The rectifier 44 may be formed in any manner, such as using solid-state diodes to implement a full-wave bridge rectifier. Those skilled in the art will readily recognize that various rectifying circuits may be used. The power converter 40 may also include a PFC converter circuit 48 that is coupled to the output of the rectifier 44. The PFC converter circuit 48 may be operable to control the current drawn from the AC power source 42 and the voltage delivered to a load, as previously described. For example, the PFC converter 48 may include a boost type converter, buck type converter, or the like.

The power converter 40 may also include a PFC bypass circuit 46. The PFC bypass circuit 46 may be operable to deliver power from the AC power source 42 directly to a load, bypassing the PFC converter circuit 48, when certain circuit conditions are present. As shown, the PFC bypass circuit 46 may also bypass the rectifier 44, but it should be understood that this is merely an example. For instance, the PFC bypass circuit 46 may be coupled to the output of the rectifier 44 so that the PFC bypass circuit 46 receives rectified voltage and current and delivers power directly to a load.

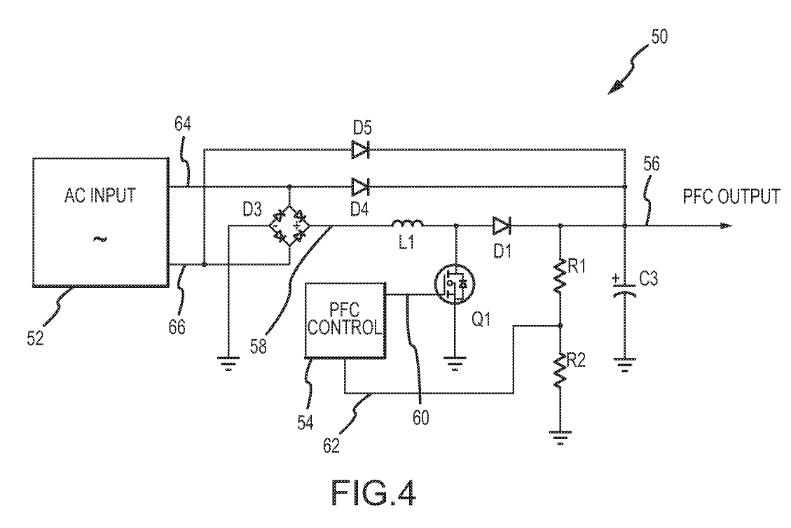

Generally, a purpose of the PFC bypass circuit 46 is to reduce the amount of power that the PFC converter 48 must supply for a given application. In doing so, the PFC converter 48 may be designed to include power components that are smaller in size and cost, which may be desirable in space-constrained applications such as portable electronics. Furthermore, by bypassing the PFC converter 48 under certain circuit conditions, the PFC converter 48 may be turned off during certain times. This has the advantage of reducing the power losses associated with the PFC converter 48, and thereby increasing the overall power conversion efficiency of the power converter 40. The details of the operation of the PFC bypass circuit 46 are discussed in greater detail with reference to FIGS. 4-7.

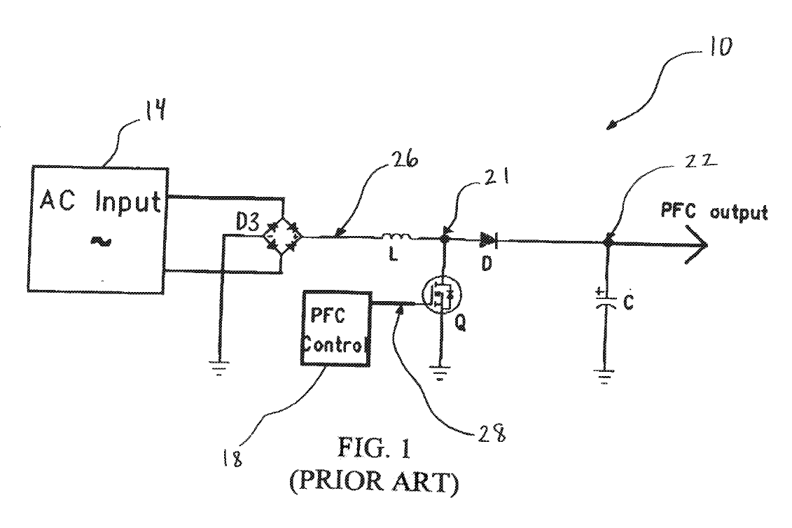

Turning now to FIG. 4, a schematic diagram of an exemplary power converter 50 is shown. Similar to the PFC circuit 10 shown in FIG. 1, the power converter 50 includes a diode rectifier D3 that is coupled to the output terminals 64, 66 of an AC power source 52. Through a rectifier output node 58, the output of the diode rectifier D3 is coupled to a boost converter portion that includes a PFC control circuit 54, an inductor L1, a transistor switch Q1, a diode D1, and a bulk capacitor C3. The PFC control circuit 54 may operate to control the switching of the transistor switch Q1 via a switch control node 60 that is coupled to the gate of the switch Q1. By controlling the switching frequency, the PFC control circuit 54 may function to adjust the power factor of the power converter 50 by controlling the current drawn from the AC power source 52. The PFC control circuit 54 may include a commercially available integrated circuit, such as the Power Factor Corrector L6561 manufactured by STMicroelectronics. Alternatively or additionally, the PFC control circuit 54 may include custom circuitry.

In this embodiment, a bypass circuit that includes two bypass diodes D4, D5 is provided. The diodes D4, D5 may be general-purpose diodes known to those having ordinary skill in the art. The diode D4 may be coupled between the output terminal 64 of the AC power source 52 and a PFC output node 56. Similarly, the diode D5 is coupled between the output terminal 66 of the AC power source 52 and the PFC output node 56. As can be appreciated, the diodes D4, D5 will be reverse biased when the voltage at the PFC output node 56 is greater than the voltage at the AC power source 52 output nodes 64, 66, respectively, and forward biased when the voltage on the output nodes 64, 66, respectively, is greater than the voltage on the PFC output node 56 (neglecting any voltage drop across the diodes D4, D5). In this regard, the boost converter portion of the power converter may be bypassed when either of the diodes D4, D5 is conducting current. That is, current from the AC power source 52 may be delivered directly to a load via the bypass diodes D4, D5.

In operation, the power converter 50 may include an output voltage sensing circuit that includes a voltage divider implemented by coupling two resistors R1 and R2 in series between the PFC output node 56 and ground. A voltage that corresponds to the voltage at the PFC output node 56 may be sensed by coupling a node 62 between the two resistors R1, R2 to the PFC control circuit 54. The PFC control circuit 54 may then control the switching of the switch Q1 to regulate the voltage at the PFC output node 56 to a level that is less than a peak AC voltage of the AC power source 52 (e.g., 90% of the peak voltage of the AC power source 52). In this regard, the diodes D4, D5 will conduct current directly from the AC power source 52 to the PFC output node 56 when the magnitude of the AC input voltage rises above the DC voltage at the PFC output node 56, effectively bypassing the boost converter portion of the power converter 50.

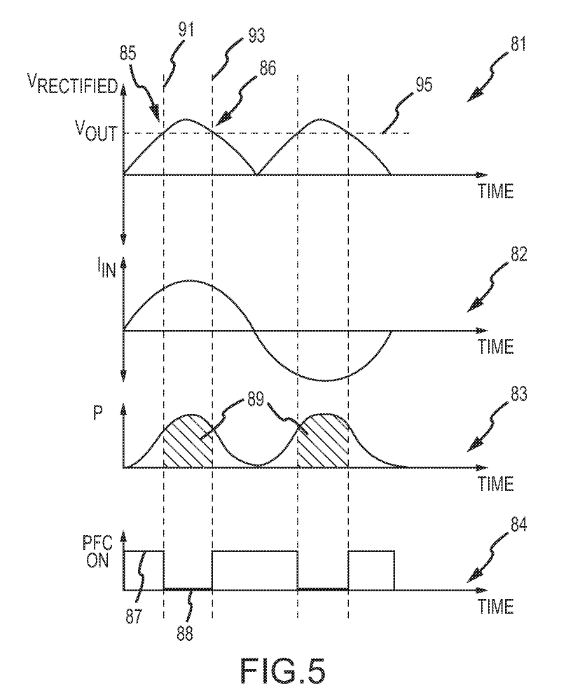

To further explain the operation of the power converter 50, a timing diagram that graphically represents four waveforms associated with the power converter 50 of FIG. 4 is provided in FIG. 5. A graph 81 illustrates the rectified input voltage of the power converter 50 at the output of the rectifier D3 (i.e., the rectifier output node 58 in FIG. 4). A graph 82 illustrates the input current drawn from the AC power source 52. A graph 83 illustrates the power available to be delivered to a load. A graph 84 illustrates when the PFC converter portion of the power converter 50 is functioning. For example, the PFC converter portion is operating at the point indicated by an arrow 87, and not operating at the point indicated by an arrow 88. In addition to illustrating the rectified input voltage, the graph 81 also shows the output voltage of the power converter 50 (i.e., the node 56 shown in FIG. 4), which is indicated by a dashed line 95. As can be seen in the graph 81, the output voltage is regulated by the PFC control circuit 54 to be at a level that is less than the peak of the rectified input voltage. As the rectified input voltage reaches the level of the output voltage at a point 85 on the graph 81 (and a dashed line 91 that represents that point in time), the PFC converter portion of the power converter 50 will turn off, due to the bypass diode D4 becoming forward biased and conducting current directly to a load. The PFC converter portion of the power converter 50 will continue to be inactive until the input voltage drops to approximately the level of the output voltage at a point 86 on the graph 81 (a corresponding dashed line 93 represents that point in time). At this point, the bypass diode D4 becomes reverse biased (the diode D5 was already reverse biased), and the PFC converter portion operates to deliver power to the load. Similarly, the PFC converter portion of the power converter 50 will turn off when the input voltage drops to a sufficiently negative level such that the diode D5 is forward biased.

Shaded regions 89 shown in the graph 83 illustrate the portion of the total power that is delivered directly through the bypass diodes D4, D5. Since the PFC converter portion is bypassed when the input voltage is near its peak where the power is greatest, the PFC converter portion of the power converter 50 only delivers a fraction (e.g., 20 to 50 percent) of the total power to the load. As discussed above, this feature has the advantage of allowing the PFC power components (e.g., the inductor L1, the switch Q1, the diode D1) to be relatively smaller in size and lower in cost. Furthermore, since the PFC converter portion is automatically turned off for a portion of the AC cycle, the losses associated with it are eliminated during that time, which improves the overall efficiency of the power converter. Another advantage of the power converter 50 is that the PFC converter portion may be automatically turned off during the entire portion of the AC cycle when the power converter is coupled to a relatively light load. This is the case because the bypass diodes D4, D5 alone may be capable of delivering sufficient power to a light load. As described above, this will increase the efficiency of the power converter 50 because the losses associated with the PFC converter portion will be reduced or eliminated under these conditions. To further increase the efficiency of the power converter 50, various circuits (e.g., the PFC control circuit 54) may be placed into a low-power operating mode (e.g., sleep or standby mode) when the PFC converter portion is not in operation.

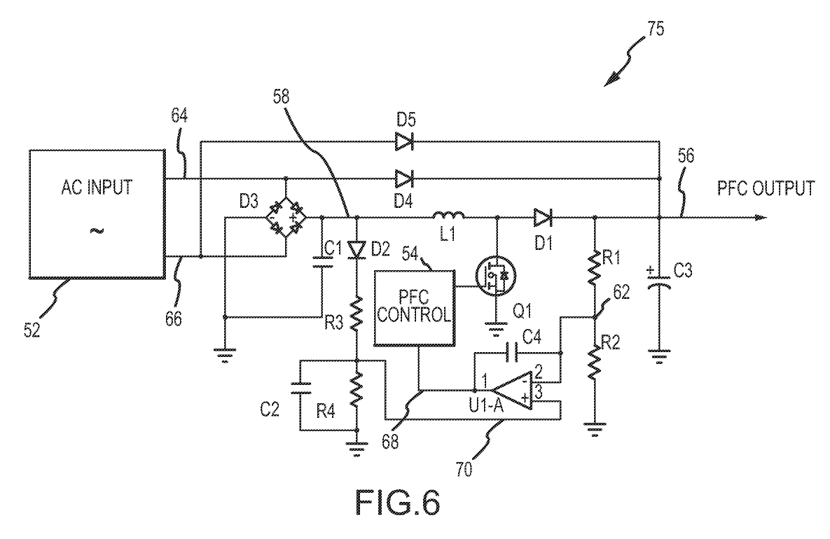

FIG. 6 is a schematic diagram of another embodiment of an exemplary power converter 75. As the power converter 75 is similar to the power converter 50 shown in FIG. 4, only the additional features are explained herein. Initially, the power converter 75 includes a filter capacitor C1 that is coupled between the rectifier output node 58 and ground. The capacitor C1 may function to reduce the harmonic distortion seen by the AC power source 52 that may be caused by the operation of the PFC control circuit 54. Furthermore, as described above, in order for the bypass diodes D4, D5 to conduct current from the AC power source 52 directly to the load, the voltage at the PFC output node 56 must be less than the peak AC input voltage at the nodes 64, 66. To enable the PFC control circuit 54 to regulate the voltage at the PFC output node 56, it may be desirable to sense the peak input voltage and the PFC output voltage. In this embodiment, this task is accomplished by including an output voltage divider that includes two resistors R1, R2 coupled in series between the PFC output node 56 and ground. To sense the peak input voltage, an input voltage divider is provided that includes a diode D2 and resistors R3, R4 coupled in series between the rectifier output node 58 and ground. Additionally, a capacitor C2 may be coupled in parallel to the resistor R4 to filter out high frequency noise across the input voltage divider.

To provide feedback to the PFC control circuit 54 so that it may regulate the output voltage at the PFC output node 56, an operational amplifier (op-amp) U1-A may be used. In this embodiment, an output voltage divider node 62 of the output voltage divider may be coupled to the inverting pin of the op-amp U1-A. Similarly, an input voltage divider node 70 of the input voltage divider may be coupled to the non-inverting pin. A capacitor C4 may be coupled between the inverting pin and the output pin (i.e., an op-amp output node 68) of the op-amp U1-A to provide feedback compensation, which may increase the stability of the output signal of the op-amp U1-A. The resistors R1, R2, R3, R4 may be chosen so the voltage at the output voltage divider node 62 and the input voltage divider node 70 are equal when the voltage at the PFC output node 56 is a predetermined percentage (e.g., 90 percent) of the peak input voltage at the rectifier output node 58. Those skilled in the art will readily recognize that various values for the resistors R1, R2, R3, R4 may be chosen to achieve the desired functionality. In operation, when the PFC output node 56 is at a level that is less than the predetermined percentage of the peak input voltage, the output pin of op-amp U1-A will provide a signal to the PFC control circuit 54 via the op-amp output node 68. That is, the output of the op-amp U1-A will be driven high because the voltage at the non-inverting input (i.e., the input voltage divider node 70) will be higher than the voltage at the inverting input (i.e., the output voltage divider node 62). The PFC control circuit 54 may then increase the voltage at the PFC output node 56 by controlling the operation of the switch Q1. For example, the PFC control circuit 54 may increase voltage at the PFC output node 56 until the output pin of the op-amp U1-A is again driven low, which is indicative that the voltage at the PFC output node 56 is equal to or greater than the predetermined percentage of the peak input voltage. As can be appreciated, this feedback system may be used to continuously regulate the voltage at the PFC output node 56.

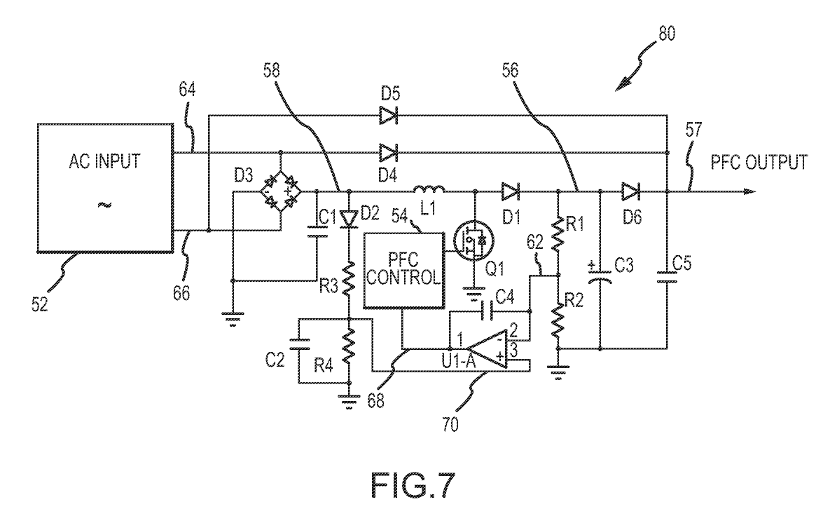

FIG. 7 is a schematic diagram of another embodiment of an exemplary power converter 80. The power converter 80 is similar to the power converter 75 shown in FIG. 6, so only the additional features are discussed. In this embodiment, a current-shaping circuit that includes a block diode D6 and a capacitor C5 is provided. The anode of the diode D6 may be coupled to the PFC output node 56, and the cathode may be coupled to a node 57. Additionally, the capacitor C5 may be coupled between the node 57 and ground. As can be seen, the bypass diodes D4, D5 are coupled to the node 57, rather than the PFC output node 56 as in previously described embodiments. This configuration may be used to further increase the power factor of the power converter 80. In operation, the diode D6 serves to block the bulk capacitor C3 from the current drawn directly from the AC power source 52, so that the AC power source 52 only charges the capacitor C5 when the diodes D4, D5 are conducting current. Generally, the capacitor C5 has a capacitance value that is less than the value of the bulk capacitor C3. This may increase the impedance that the AC power source 52 sees when the diodes D4, D5 are conducting current during the peak portion of the AC input voltage. By selecting the capacitor C5 to increase this impedance, the current drawn from the AC power source 52 may be shaped to be more sinusoidal, which has the effect of increasing the power factor and efficiency of the power converter 80.

It should be appreciated that the power converter described herein has several benefits and advantages over previous designs. By automatically bypassing the PFC converter circuitry during portions of the AC cycle, the power converter may be designed with relatively smaller and less expensive components. Additionally, since the PFC converter circuitry does not provide the total power to the load, the power losses associated with the PFC converter are reduced, which improves the efficiency of the power converter. Furthermore, by regulating the output voltage to be less than the peak input voltage so that the bypass diodes D4, D5 are forward biased during portions of each AC cycle, the PFC converter circuit may be automatically bypassed without requiring complex and expensive control circuitry.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed:

1. A power converter that is capable of receiving AC power from an AC power source on an input terminal and delivering DC power to a load on an output terminal, the power converter comprising:
a rectifier having an input terminal coupled to the AC power source, and an output terminal, the rectifier being operable to receive an AC voltage on its input terminal and deliver a rectified voltage on its output terminal;
a power factor correction circuit having an input terminal coupled to the output terminal of the rectifier, and an output terminal coupled to the output terminal of the power converter, the power factor correction circuit being operable to modify the power factor of the power converter, and being operable to deliver DC power to a load; and
an auxiliary circuit that operates to bypass the power factor correction circuit when the magnitude of the voltage of an output terminal of the AC power source is greater than the voltage of the output terminal of the power converter.

2. The power converter of claim 1, wherein the auxiliary circuit is operable to pass current from the AC power source to a load.

3. The power converter of claim 2, wherein a majority of the current drawn from the AC power source passes through the auxiliary circuit during at least a portion of a cycle of the AC power source.

4. The power converter of claim 1, wherein the auxiliary circuit operates to bypass the power factor correction circuit during at least a portion of a cycle of the AC power source.

5. The power converter of claim 1, wherein the auxiliary circuit comprises a diode having an anode and a cathode, the anode being coupled to a node between the AC power source and the input terminal of the power factor correction circuit, and the cathode being coupled to a node between the output terminal of the power factor correction circuit and the output terminal of the power converter.

6. The power converter of claim 1, wherein the auxiliary circuit comprises:
a first diode, the first diode having an anode that is coupled to a first output terminal of the AC power source, and a cathode that is coupled to the output terminal of the power converter; and
a second diode, the second diode having an anode that is coupled to a second output terminal of the AC power source, and a cathode that is coupled to the output terminal of the power converter.

7. The power converter of claim 1, wherein the power factor correction circuit is further operable to regulate the voltage at the output terminal of the power converter to a level that is less than or equal to a peak voltage of the AC power source.

8. The power converter of claim 7, wherein the power factor correction circuit is operable to regulate the voltage at the output terminal of the power converter to a level that is approximately between 80 percent and 100 percent of the peak voltage of the AC power source.

9. The power converter of claim 1, wherein the power factor correction circuit includes a first sensing circuit that is operable to sense the output voltage at the output terminal of the power converter, and wherein the power factor correction circuit is operable to regulate the voltage at the output terminal of the power converter dependent on the sensed output voltage.

10. The power converter of claim 9, wherein the power factor correction circuit further includes a second sensing circuit that is operable to sense an input voltage that corresponds to the instantaneous voltage of the AC power source, and wherein the power factor correction circuit is operable to regulate the voltage at the output terminal of the power converter dependent on the sensed input voltage.

11. The power converter of claim 1, wherein the power factor correction circuit includes an integrated circuit, the integrated circuit being operable to function at a reduced power level under predetermined conditions.

12. The power converter of claim 1, wherein the power factor correction circuit includes:
an inductor having a first and second terminal, the first terminal being coupled to the input terminal of the power factor correction circuit;
a diode having an anode coupled to the second terminal of the inductor, and a cathode coupled to the output terminal of the power factor correction circuit;
a controllable switch having a first terminal and a second terminal, the first terminal being coupled to a junction between the inductor and the diode, and the second terminal being coupled to ground;
a control circuit for switching the controllable switch on and off at a high frequency; and
a capacitor coupled between the cathode of the diode and ground.

13. A power converter that is capable of receiving AC power from an AC power source on an input terminal and delivering DC power to a load on an output terminal, the power converter comprising:
a rectifier having an input terminal coupled to the AC power source, and an output terminal, the rectifier being operable to receive an AC voltage on its input terminal and deliver a rectified voltage on its output terminal;
a power factor correction circuit having an input terminal and an output terminal, the input terminal being coupled to the output terminal of the rectifier, the power factor correction circuit being operable to modify the power factor of the power converter, and being operable to deliver DC power to a load;
an auxiliary circuit that operates to bypass the power factor correction circuit when the magnitude of the voltage of an output terminal of the AC power source is greater than the voltage of the output terminal of the power converter; and
a current-shaping circuit having an input terminal that is coupled to the output terminal of the power factor correction circuit, and an output terminal that is coupled to the output terminal of the power converter, wherein the current-shaping circuit is operable to reduce the harmonic distortion of an electrical current of the AC power source.

14. The power converter of claim 13, wherein the current-shaping circuit comprises:
a diode having an anode coupled to the output terminal of the power factor correction circuit, and a cathode coupled to the output terminal of the power converter; and
a first capacitor coupled between the cathode of the diode and ground.

15. The power converter of claim 14, wherein the power converter further includes a second capacitor coupled between the output terminal of the power converter and ground, and wherein the first capacitor has a lower capacitance than the second capacitor.

16. The power converter of claim 13, wherein the auxiliary circuit is operable to pass current from the AC power source to a load.

17. The power converter of claim 16, wherein a majority of the current drawn from the AC power source passes through the auxiliary circuit during at least a portion of a cycle of the AC power source.

18. The power converter of claim 13, wherein the auxiliary circuit comprises a diode having an anode and a cathode, the anode being coupled to a node between the AC power source and the input terminal of the power factor correction circuit, and the cathode being coupled to a node between the output terminal of the power factor correction circuit and the output terminal of the power converter.

19. The power converter of claim 13, wherein the auxiliary circuit comprises:
a first diode, the first diode having an anode that is coupled to a first output terminal of the AC power source, and a cathode that is coupled to the output terminal of the power converter; and
a second diode, the second diode having an anode that is coupled to a second output terminal of the AC power source, and a cathode that is coupled to the output terminal of the power converter.

20. The power converter of claim 13, wherein the power factor correction circuit is further operable to regulate the voltage at the output terminal of the power converter to a level that is less than or equal to a peak voltage of the AC power source.

21. A method for use in a power converter, the power converter being operable to receive AC power from an AC power source on an input terminal and delivering DC power to a load on an output terminal, the method comprising:
converting an input AC voltage to a rectified voltage;
supplying the rectified voltage to a power factor correction circuit, the power factor correction circuit being operable to modify the power factor of the power converter, and being operable to deliver DC power to a load;
regulating an output voltage of the power factor correction circuit to a level that is less than a peak voltage of the AC power source; and
bypassing the power factor correction circuit when the magnitude of the voltage of an output terminal of the AC power source is greater than the voltage of the output terminal of the power converter.

22. The method of claim 21, wherein the bypassing includes passing current from the AC power source to the load.

23. The method of claim 22, wherein the bypassing includes passing a majority of the current drawn from the AC power source to the load during at least a portion of a cycle of the AC power source.

24. The method of claim 21, wherein the bypassing includes passing current from the AC power source to the load through a diode.

25. The method of claim 21, wherein the bypassing includes:
passing current from a first output terminal of the AC power source to the load through a first diode; and
passing current from a second output terminal of the AC power source to the load through a second diode.
